(19) United States
(12) Patent Application Publication
(10) Pub. No.: US 2014/0075922 A1
(43) Pub. Date: Mar. 20, 2014

(54) Ammonia storage device and exhaust line equipped with such a device

(71) Applicant: Faurecia Systemes D'Echappement, Nanterre (FR)

(72) Inventor: Sebastien Guinehut, Belfort (FR)

(73) Assignee: Faurecia Systemes D'Echappement, Nanterre (FR)

(21) Appl. No.: 14/023,789

(22) Filed: Sep. 11, 2013

(30) Foreign Application Priority Data
Sep. 14, 2012 (FR) 1258659

(51) Int. Cl. F17C 11/00; F01N 3/20

(52) U.S. Cl. CPC F17C 11/00; F01N 3/208
USPC 60/282; 206/7

(57) ABSTRACT

An ammonia storage device has an enclosure, a solid material provided to absorb and desorb ammonia, and a heating member that heats the solid material. The storage device also has a metal foam that is positioned in the enclosure and which has open pores. The solid material essentially includes particles of suitable sizes to be housed in the pores.

### RELATED APPLICATION

This application claims priority to FR 12 58659, filed Sep. 14, 2012.

### TECHNICAL FIELD

The invention generally relates to ammonia storage devices, in particular for injecting ammonia into a motor vehicle exhaust line. More specifically, the invention relates to an ammonia storage device that comprises an enclosure, a solid material provided to absorb and desorb ammonia, and a heating member that heats the solid material.

### BACKGROUND

One ammonia storage device is, for example, known from EP 2,316,558. This document describes that the solid material provided to absorb or desorb the ammonia is a metal salt, such as MgCl₂ or SrCl₂.

In this device, it is necessary to effectively heat the entire mass of solid material to cause the desorption of as much ammonia as possible. This is not easy to obtain when, for example, the heating member is a resistive member, heated by conduction through the enclosure of the device.

In this context, the invention aims to propose an ammonia storage device that allows more uniform heating of the entire mass of solid material.

### SUMMARY

An ammonia storage comprises a metal foam that is positioned in an enclosure and which has open pores. The solid material essentially includes particles of suitable sizes to be housed in the pores.

The metal foam makes it possible to conduct heat very effectively to the particles positioned in the pores.

The heating is even more effective when the particles are small.

Typically, the metal foam fills the majority of the inner volume of the enclosure, preferably more than 75% of that inner volume, and still more preferably more than 90% of that volume.

Advantageously, at least 50% of the mass of solid material is housed in the pores of the metal foam, preferably at least 75% of the total mass of solid material, and still more preferably at least 90% of the total mass of solid material.

The metal foam typically assumes the form of a block, substantially having a shape conjugated with the inner volume of the enclosure. Thus, for a cylindrical enclosure, the metal foam block will have a shape that is also cylindrical. The metal foam preferably makes up a single block, in a single piece. Alternatively, the metal foam is made up of several blocks.

The enclosure delimits a closed inner volume, with an orifice for discharging desorbed ammonia. This desorption is caused by heating of the solid material.

The pores are open in that they communicate with each other, and allow the desorbed ammonia from the solid material to escape outside the metal foam, as far as the outlet orifice arranged in the enclosure.

The solid material is a material advantageously described in EP 2,316,558. For example, this solid material is a metal salt, for example MgCl₂ or SrCl₂.

The enclosure is typically a metal material, for example steel or aluminum. Alternatively, the enclosure is made from a composite material.

The device may also have one or more of the features below, considered individually or according to all technically possible combinations.

Advantageously, the foam is an aluminum or aluminum alloy foam. Such a material is light, cost-effective, and conducts heat well.

Alternatively, the foam is not made from aluminum, but another light material that conducts heat well, for example magnesium.

Typically, the open pores of the foam have an average diameter comprised between 0.1 and 10 mm. Preferably, these pores have a diameter comprised between 0.5 and 5 mm, and still more preferably 1 and 2 mm.

The average diameter here refers to the statistical average of the diameters, taken for all pores of the metal foam. The diameter of a pore, for example, corresponds to the sum of its maximum dimension and its minimum dimension, divided by two.

As indicated above, the solid material assumes the form of solid particles. When they are not charged with ammonia, these particles advantageously have an average diameter comprised between 50 μm and 5 mm, preferably comprised between 60 μm and 500 μm, and typically equal to between 100 and 200 μm. When they are saturated with ammonia, these particles typically have a diameter comprised between 300 and 400 μm.

Average diameter here refers to the statistical average of the diameters of the entire population of particles. The diameter of a particle, for example, corresponds to the sum of the minimum dimension of that particle and its maximum dimension, divided by two.

In each pore of the metal foam, there are one or more particles of solid material, based on the size of the pore and the size of the particles.

In one example embodiment, the heating member is situated outside the enclosure. For example, the heating member is a resistive member pressed against the enclosure. The heating member heats by conduction through the wall of the enclosure. It, for example, includes one or more electrical resistances arranged around the enclosure, for example resistive wires. Alternatively, the heating member is a double enclosure in which a heat transfer fluid circulates.

According to another example embodiment, the heating member heats by induction, or another wave type, through the wall of the enclosure.

Alternatively, the heating member is a glow plug that is situated inside the enclosure. The glow plug, for example, extends along a central axis of the enclosure, and heats the material around it by conduction. It typically comprises an electrical resistance, optionally housed inside a body to be protected. In that case, the metal foam includes a housing intended to receive the glow plug. Preferably, the outer surface of the glow plug is in contact with the inner surface of the housing.

Alternatively, the heating member includes two electrodes placed inside the enclosure, and an electrical generator electrically connected to the two electrodes, to circulate an electrical current in the metal foam.

For example, the two electrodes are placed at two opposite ends of the enclosure, the metal foam being housed between the two electrodes, and electrically in contact with the two electrodes. The metal foam therefore constitutes a resistive member, converting the electrical current into heat. In that case, an insulating layer is typically provided between the metal foam and the enclosure.

Advantageously, the outer enclosure is rigidly fastened to the metal foam, for example by welding.

This makes it possible to stiffen the outer enclosure, and to improve its mechanical pressure resistance properties. Thus, it is for example possible to decrease the wall thickness of the enclosure.

The fastening of the outer enclosure to the metal foam is typically done by multiple weld points or lines.

These welds are done from the outside of the enclosure, through that enclosure. The weld lines or points are distributed substantially uniformly over the entire wall of the enclosure.

According to one alternative embodiment, the enclosure is a skin integral with the metal foam.

The structure of the device is thus considerably simplified. In other words, the enclosure is made up of an outer area of the metal foam block, not including pores. The thickness of that area is sufficient to ensure pressure resistance of the device. The skin is obtained during the manufacture of the metal foam block, or alternatively is obtained during a subsequent step consisting of closing the pores of the metal foam block over at least part of its outer surface.

According to one alternative embodiment, the enclosure delimits an inner volume that has a plurality of zones not occupied by the metal foam, and which are separated from each other by zones that are occupied by the metal foam. These zones are typically filled with solid material. The quantity of solid material that can be stored in the enclosure is thus increased, as is the quantity of available ammonia.

Alternatively, these zones are empty and serve as a buffer reservoir for the gaseous ammonia.

For example, the zones occupy between 5 and 50% of the inner volume, preferably between 10 and 30%, and for example between 10 and 20%.

According to a second aspect, the invention relates to a vehicle exhaust line comprising an ammonia storage device having the above features. The vehicle is, for example, a car, a utility vehicle, or a truck.

The exhaust line typically comprises an SCR (Selective Catalytic Reduction) catalyst. The ammonia is injected in gaseous form, immediately upstream from the SCR catalyst. In the SCR catalyst, the ammonia reacts with the NOx, and converts them into N₂.

These and other features may be best understood from the following drawings and specification.

### BRIEF DESCRIPTION OF THE DRAWINGS

Other features and advantages of the invention will emerge from the detailed description thereof provided below, for information and limitingly, in reference to the appended figures, in which:

FIG. 1 shows an exhaust line equipped with an ammonia storage device according to the invention;

FIG. 2 shows a more detailed view of the storage device of FIG. 1, in cross-section, with a heating member placed outside the enclosure;

FIGS. 3 and 4 are views similar to that of FIG. 2, showing alternative embodiments of the heating member;

FIG. 5 is an enlarged view of part of the metal foam block, showing that the latter has an outer skin forming the enclosure of the device; and

FIG. 6 is a view similar to that of FIG. 3, for an alternative embodiment in which the metal foam does not completely occupy the inner volume of the enclosure.

### DETAILED DESCRIPTION

FIG. 1 shows an ammonia storage device 1, provided to supply a flow of gaseous ammonia to a motor vehicle exhaust line 3. The exhaust line 3 is provided to capture the exhaust gases coming from the combustion chambers of the heat engine 5 of the vehicle. It includes an SCR (Selective Catalytic Production) catalyst 7. The device 1 injects the gaseous ammonia upstream from the SCR catalyst, into a duct 9 of the exhaust line. In the SCR catalyst, the ammonia NH₃ reacts with the NOx that are contained in the exhaust gases. The NOx are converted into gaseous N₂ and water H₂O.

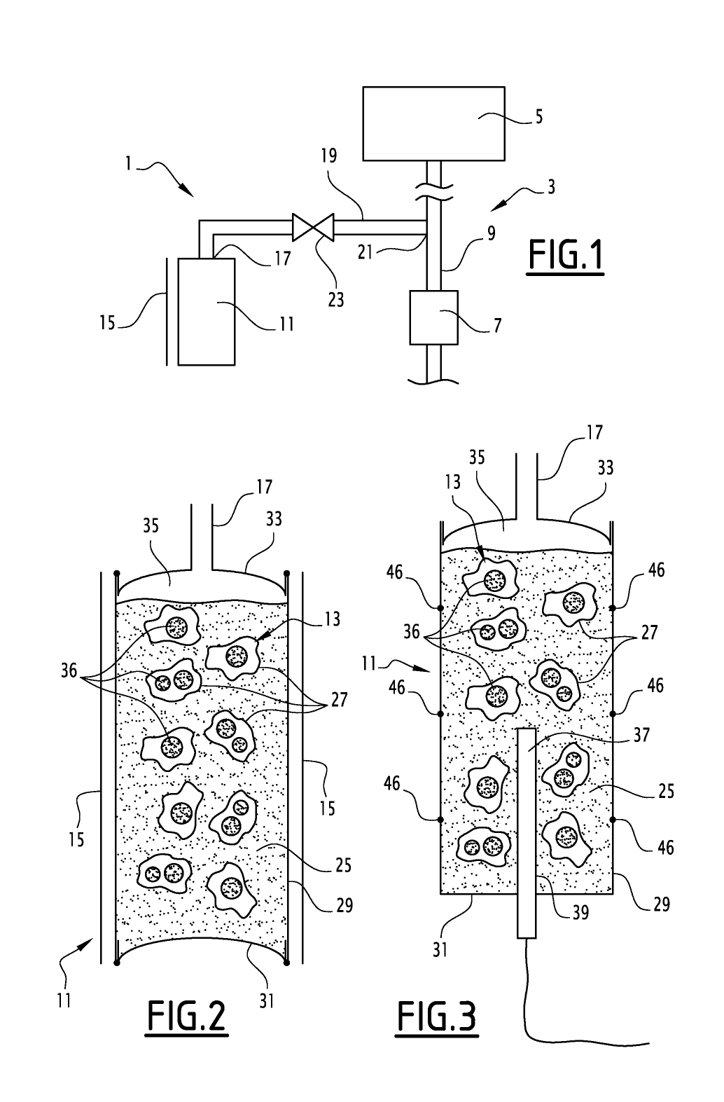

The device 1 includes an enclosure 11, a solid material 13 (shown in FIGS. 2 to 4) provided to absorb and desorb the ammonia, and a heating member 15 for heating the solid material. The enclosure 11 delimits a closed inner volume, having an outlet 17 for the ammonia. The outlet 17 is fluidly connected by a duct 19 to an injection member 21 for injecting ammonia into the exhaust line. The device further comprises a metering unit 23 inserted in the duct 19. The metering unit 23 is provided to monitor the quantity of ammonia injected into the exhaust line 3. This metering unit is for example of the type described in WO 2011/113454 or WO 2001/121196.

As shown in FIG. 2, the storage device 1 comprises a metal foam 25, positioned in the enclosure 11, and having open pores 27. In these figures, the size of the pores has been exaggerated for clarity reasons. In the illustrated example, the metal foam 25 assumes the form of a block with a shape substantially conjugated with the inner volume of the enclosure. The foam 25 fills the entire inner volume of the enclosure 11, with the exception of a zone 35 of the inner volume that adjoins the outlet 17. In particular, the foam 25 touches the enclosure 11 over the majority of said enclosure.

For example, the enclosure 11 has a generally cylindrical shape, with a tubular wall 29, a lower bottom 31 closing one lower end of the tubular 29 wall and an upper bottom 33, bearing the outlet 17 and closing an upper end of the tubular wall 29. The metal foam 25 is in contact with both with the lower bottom 31 and the wall 29.

The zone 35 of the inner volume situated immediately below the upper bottom 33 is free in that it does not include any metal foam.

The metal foam 25 is an aluminum foam typically including between 197 and 1969 pores per linear meter. The pores have diameters comprised between 5 and 0.5 mm.

The solid material is a metal salt, for example SrCl₂. This material is finely divided, and assumes the form of a large number of particles 36, with sizes suitable for being housed in the pores of the metal foam. More specifically, the solid material is made up of particles 36 which, when they are not charged with ammonia, have an average diameter of approximately 100 microns. These particles, when saturated with ammonia, have an average diameter comprised between 300 and 400 microns. The size of the particles has been exaggerated in the figures for clarity reasons.

The majority of the particles 36 are housed in the pores 27 of the metal foam. A small proportion of said particles 36 are housed in the zone 35, situated immediately below the upper bottom 33.

In the example embodiment of FIG. 2, the heating member 15 is an electrical resistance, placed outside the enclosure 11. The electrical resistance is pressed against the enclosure 11. It includes a plurality of resistive wires, distributed over the entire tubular wall 29 of the enclosure.

In the alternative embodiment of FIG. 3, the heating member 15 is a plug 37, placed inside the enclosure 11. The metal foam 25 then has a housing 39, in which the plug 37 is received. The plug 37, for example, extends along a central axis of the enclosure 11. It is supported by the lower bottom 31. The plug 37, for example, includes a gastight body and a heating electrical resistance engaged inside the body. The body conducts heat and is pressed against the wall of the housing 39.

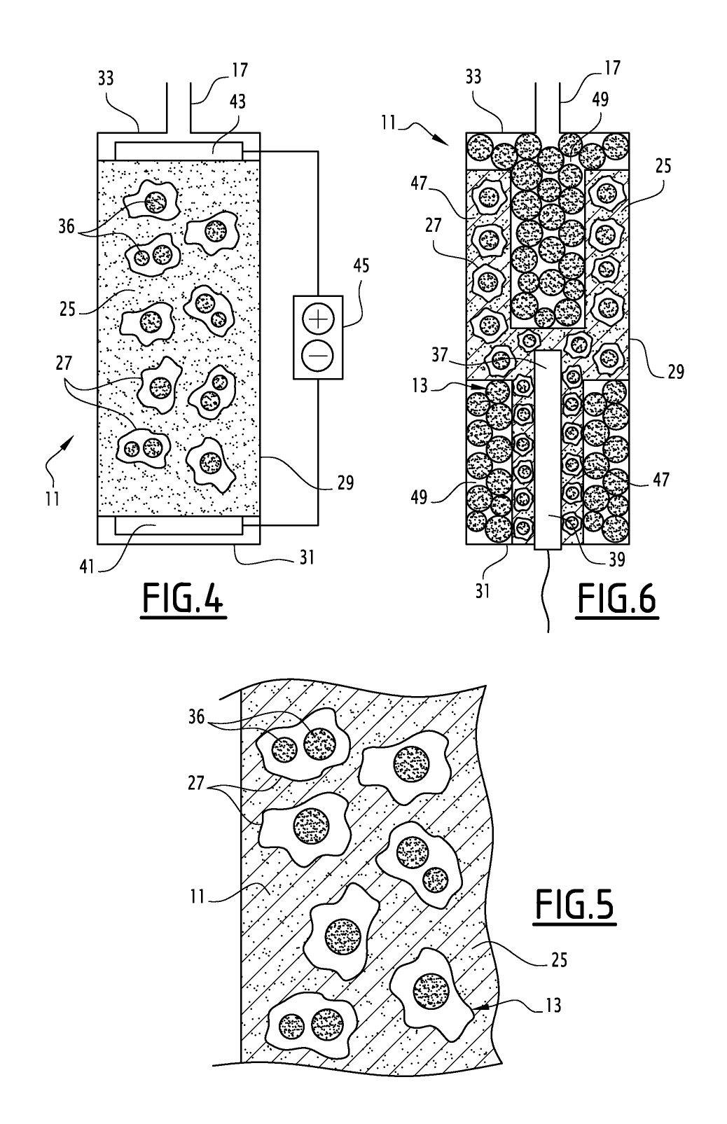

In the alternative embodiment of FIG. 4, the heating member 15 includes two electrodes 41, 43 and an electrical generator 45, electrically connected to the two electrodes 41, 43. The two electrodes 41, 43 are placed inside the enclosure 11, at two opposite ends thereof. For example, the electrode 41 is placed against the lower bottom 31 and the electrode 43 is placed against the upper bottom 33. The metal foam 25 is positioned between the two electrodes 41, 43, and is electrically in contact with each of the two electrodes 41, 43. When the electrical generator 45 operates, an electrical current circulates from the electrode 41 to the electrode 43 through the metal foam 25. The metal foam 25 serves as a resistive heating member, and converts the electrical current into heat.

The enclosure 11 is rigidly fastened to the metal foam 25 by a plurality of weld lines 46 (shown in FIG. 3). These lines 46 are situated on the tubular wall 29.

In the example embodiment of FIG. 5, the enclosure 11 is partially formed by a skin integral with the metal foam 25. In one example embodiment, the skin of the metal foam 25 makes up the tubular wall 29 and the lower bottom 31 of the enclosure 11. The skin is made up of a continuous layer formed on the outer surface of the metal foam, in which the metal foam is stripped of pores. This layer has a sufficient thickness to withstand pressure from the ammonia without any fissures being created through the layer, through which the ammonia could escape.

The upper bottom 33 of the enclosure is, in that case, directly attached on the metal foam with a sealed link. The zone of the outer surface of the metal foam turned toward the upper bottom 33 includes open pores, so as to allow the ammonia to escape from the metal foam and flow to the outlet 17.

Another alternative embodiment of the invention will now be described in reference to FIG. 6. Only the points by which this alternative differs from that of FIG. 3 will be described below. Identical elements or elements performing the same function will be designated using the same references.

In the example embodiment of FIG. 6, the inner volume delimited by the enclosure includes a plurality of zones 47 occupied by the metal foam, and a plurality of zones 49 not occupied by the metal foam. The zones 49 not occupied by the metal foam are separated from each other by the zones 47 that are occupied by the metal foam. They occupy approximately 50% of the inner volume. The zones 49 not occupied by the metal foam are filled with particles of solid material. The housing 39 for receiving the plug 37 is formed in one of the zones 47 that is occupied by the metal foam.

The zones 49 not occupied by the metal foam are distributed at different points of the inner volume to facilitate the conduction of heat toward those zones, via the metal foam.

In the example of FIG. 6, the device includes two zones 49 that are not occupied by metal foam. More specifically, the device includes a first annular zone 49, surrounding a cylindrical zone 47 in which the glow plug 37 is housed. The first zone 49 is situated toward the lower bottom 31. The second zone 49 has a cylindrical shape and extends at the center of the enclosure, toward the upper bottom 33. It is surrounded by an annular zone 47. The cylindrical zone 47 is connected to the annular zone 47 by a zone of the disc-shaped foam block, thereby separating the two zones 49 from each other.

Although an embodiment of this invention has been disclosed, a worker of ordinary skill in this art would recognize that certain modifications would come within the scope of this disclosure. For that reason, the following claims should be studied to determine the true scope and content of this disclosure.

1. An ammonia storage device comprising:
an enclosure;
a solid material provided to absorb and desorb ammonia;
a heating member for heating the solid material; and
a metal foam positioned in the enclosure and having open pores, the solid material essentially including particles of suitable sizes to be housed in said pores.

2. The device according to claim 1, wherein the foam is an aluminum or aluminum alloy metal foam.

3. The device according to claim 1, wherein the pores have an average diameter comprised between 0.1 and 10 mm.

4. The device according to claim 1, wherein the particles not charged with ammonia have an average diameter comprised between 50 μm and 5 mm.

5. The device according to claim 1, wherein the heating member is situated outside the enclosure.

6. The device according to claim 1, wherein the heating member comprises a glow plug situated inside the enclosure.

7. The device according to claim 1, wherein the heating member comprises two electrodes placed inside the enclosure, and an electrical generator connected to the two electrodes, to circulate an electrical current in the metal foam.

8. The device according to claim 1, wherein the enclosure is rigidly fastened to the metal foam by at least one weld line.

9. The device according to claim 1, wherein at least part of the enclosure is a is a skin integral with the metal foam.

10. The device according to claim 1, wherein the enclosure delimits an inner volume that has a plurality of zones not occupied by the metal foam, and which are separated from each other by zones that are occupied by the metal foam.

11. A vehicle exhaust system comprising:
an exhaust line; and
an ammonia storage device associated with the exhaust line, and wherein the ammonia storage device includes an enclosure, a solid material provided to absorb and desorb ammonia, a heating member for heating the solid material, and a metal foam positioned in the enclosure and having open pores, the solid material essentially including particles of suitable sizes to be housed in said pores.
